(19) United States
(12) Patent Application Publication
(10) Pub. No.: US 2010/0295667 A1
(43) Pub. Date: Nov. 25, 2010

(54) MOTION BASED POINTING APPARATUS PROVIDING HAPTIC FEEDBACK AND CONTROL METHOD THEREOF

(75) Inventors: Ki-Uk KYUNG, Daejeon-city (KR); Jun-Seok PARK, Daejeon-city (KR); Jeun-Woo LEE, Daejeon-city (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon-city (JP)

(21) Appl. No.: 12/784,999

(22) Filed: May 21, 2010

(30) Foreign Application Priority Data
May 22, 2009 (KR) 10-2009-0044750
Oct. 1, 2009 (KR) 10-2009-0094015

(51) Int. Cl. G08B 6/00

(52) U.S. Cl. 340/407.2

(57) ABSTRACT

Provides is a motion based pointing apparatus including a pointing unit that includes an operating sensor sensing a motion of a user and a haptic output unit providing haptic feedback to the user; and a terminal unit that operates pointers displayed on a screen from the motion of the user sensed by the pointing unit and outputs haptic information corresponding to a change in the screen due to the motion of the pointer and the operation of the pointer to the pointing unit, wherein the pointing unit outputs haptic operation according to the haptic information output from the terminal unit.

### RELATED APPLICATIONS

The present application claims priority to Korean Patent Application Serial Number 10-2009-0044750, filed on May. 22, 2009 and Korean Patent Application Serial Number 10-2009-0094015, filed on Oct. 1, 2009, the entirety of which are hereby incorporated by reference.

### BACKGROUND OF THE INVENTION

1. Field of the Invention

The present invention relates to a motion based pointing apparatus providing haptic feedback and a control method thereof, and more specifically, to a motion based pointing apparatus providing haptic feedback capable of operating objects on a screen and graphic user interface elements by a motion of hands and at the same time, feeling the haptic sensation and a control method thereof.

2. Description of the Related Art

An example of a commonly used pointing apparatus may include a remote controller that can perform operations at a remote place.

The remote controller uses a gyro sensor, etc., which controls a screen according to the rotational direction and motion of the remote controller. In addition, the remote controller includes a plurality of gyro sensors to sense motions in several ways and controls the screen according to the shaking of the remote controller.

Currently, a technology for a user to feel the haptic sensation while controlling the screen by giving haptic stimulation to the remote controller has been developed.

However, when the user operates the screen by using a pointer, a technology of providing the haptic feedback for the user to recognize his/her fine operation is not established. In other words, when the user controls the screen by using the pointer, it is not easy to sense the directivity or position of the pointer, etc., in response to the haptic feedback.

### SUMMARY OF THE INVENTION

It is an object of the present invention to provide a motion based pointing apparatus providing haptic feedback capable of operating objects on a screen and graphic user interface elements through a motion of a hand and at the same time, feeling the haptic sensation and a control method thereof.

In addition, it is another object of the present invention to provide a motion based pointing apparatus providing haptic feedback that can be used as a pointing apparatus which replaces an existing mouse and a remote controller for controlling TV, acoustic devices, etc., by controlling pointers on a screen connected to a terminal unit using the change in orientation measured according to a motion of user's hand or wrist and a control method thereof.

In order to achieve the above objects, there is provided a motion based pointing apparatus providing haptic feedback according to the present invention, including: a pointing unit that includes an operating sensor sensing a motion of a user and a haptic output unit providing haptic feedback to the user in a major axis direction or left and right directions; and a terminal unit that operates pointers displayed on a screen from the motion of the user sensed by the pointing unit and outputs haptic information corresponding to a change in the screen due to the motion of the pointer and the operation of the pointer to the pointing unit, wherein the haptic output unit includes one or more linear vibrator that generates collision or vibration in at least one of up, down, left, right, front, and rear directions according to the haptic information output from the terminal unit.

The haptic output unit collides the vibrating body of the linear vibrator or generates the vibration in one way or two ways.

The haptic output unit generates the short vibration or the vibrations that are getting stronger or weaker, at the time vibration is generated.

The haptic output unit collides the vibrating body of the linear vibrator in an opposite direction or generates vibration whenever the haptic information corresponding to the change in the screen due to the operation of the pointer or the motion of the pointer is output.

The haptic output unit generates the collision in a direction corresponding to the motion of the pointer.

The haptic output unit generates the collision or the vibration by using the vibrating bodies of two linear vibrators that are disposed to be vertical to each other in a 2-axis direction.

The haptic output unit generates the collision or the vibration by using the vibrating bodies of three linear vibrators that are disposed to be vertical to each other in a 3-axis direction.

The operating sensor includes an angular speed sensor that measures an angular speed in the 3-axis direction from the motion of the pointing unit and an acceleration sensor that measures acceleration in the 3-axis direction from the motion of the pointing unit.

The pointing unit further includes an input unit that receives a control instruction from the user and a communication unit that transmits and receives signals to and from the terminal unit.

The terminal unit includes an operating recognizer that recognizes coordinate positions on the screen corresponding to the motion of the user sensed by the pointing unit to output a control signal for controlling the operation of the pointer and recognizes the change in the screen according to the motion of the pointer or the operation of the pointer; and a haptic information extractor that extracts the haptic information corresponding to the motion of the pointer or the change in the screen that are recognized by the operating recognizer.

The haptic information extractor extracts the haptic information corresponding to at least one change among the position, moving distance, moving speed, moving orientation, and shape of the pointer and the screen selection or non-selection using the pointer.

The haptic information extractor extracts haptic information corresponding to at least one change among the window, menu, icon, emoticon, button, and pattern that are displayed on the screen and the shape, size, position, and orientation of an area that is selected by the pointer.

The haptic information extractor extracts the haptic information according to whether the objects pointed out by the pointer on the screen can be executed.

The terminal unit further includes a display unit that includes the screen and a communication unit that transmits and receives signals to and from the pointing unit.

In order to achieve the above objects, there is provided a control method of a motion based pointing apparatus providing haptic feedback according to the present invention, including: sensing a motion of a pointing unit corresponding to a motion of a user; outputting a control signal for controlling an operation of a pointer that is displayed on a screen corresponding to the motion of the pointing unit; recognizing the change in the screen according to the motion of the pointer or the operation of the pointer on the screen; outputting haptic information corresponding to the motion of the pointer or the change in the screen that are recognized at the time of recognition; and outputting haptic operation using a linear vibrator of the pointing unit according to the output haptic information.

The recognizing is performed by recognizing at least one change among the position, moving distance, moving speed, moving orientation, and shape of the pointer and the screen selection or non-selection using the pointer.

The recognizing is performed by recognizing at least one change among the window, menu, icon, emoticon, button, and pattern that are displayed on the screen and the shape, size, position, and orientation of an area that is selected by the pointer.

The recognizing is performed by recognizing whether the objects pointed out by the pointer on the screen can be executed.

The outputting the haptic operation is performed by colliding the vibrating body of the linear vibrator or generating the vibration in one way or two ways.

The outputting haptic operation is performed by generating collision or vibration in at least one of up, down, left, right, front, and rear directions using the vibrating body of the linear vibrator.

With the present invention, it can improve the performance and usability of the user interface of various devices using the haptic feedback.

In addition, the present invention gives the haptic feedback function to the user interface with respect to the operation of the pointing apparatus depending on only the visual information to improve the usability and the recognition rate of the user.

Moreover, the present invention reduces ambiguous motions that occurs when the pointing apparatus based on the motion recognition is used by the haptic feedback in order to perform a more accurate operation.

### BRIEF DESCRIPTION OF THE DRAWINGS

FIG. 1 is a diagram showing an operation of a motion based pointing apparatus providing haptic feedback according to the present invention;

FIGS. 2 and 3 are diagrams referenced for explaining a configuration of a pointing unit of the motion based pointing apparatus providing haptic feedback according to the present invention;

FIG. 4 is a diagram referenced for explaining a configuration of a terminal unit of the motion based pointing apparatus providing haptic feedback according to the present invention;

FIGS. 5 to 20 are diagrams referenced for explaining the operation of the motion based pointing apparatus providing haptic feedback according to the present invention; and

FIG. 21 is a flow chart showing an operational flow of a control method of the motion based pointing apparatus providing haptic feedback according to the present invention.

### DETAILED DESCRIPTION OF THE PREFERRED EMBODIMENTS

Hereinafter, detailed embodiments of the present invention will be described with reference to the accompanying drawings.

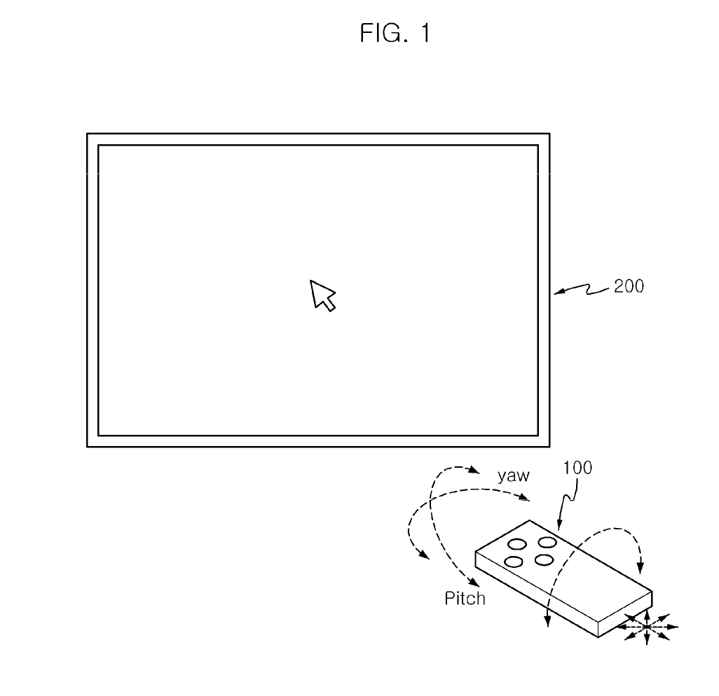

FIG. 1 is a diagram showing an operation of a motion based on a pointing apparatus providing haptic feedback according to the present invention.

As shown in FIG. 1, the motion based pointing apparatus providing haptic feedback according to the present invention largely includes a control apparatus such computer, etc., or a terminal unit 200 such as monitor, TV, etc., and includes a pointing unit 100 that controls pointers displayed on the terminal unit 200.

For example, when a user controls a screen operation of a computer monitor, the pointing unit 100 is connected to the terminal unit 200 such as computer or monitor, etc., to take a specific motion, thereby operating the pointer of the monitor and controlling the operating screen, etc.

At this time, the pointing unit 100 is provided with a sensor that can measure the motion of a user's hand, etc., such that the user grips the pointing unit 100 and performs each axial rotation (roll, pitch, yaw) or shaking operation, etc., making it possible to more conveniently and accurately operate the pointing unit while feeling the haptic motion when operating the size, position, scroll, etc., of the windows 102 displayed on the screen or moving the menus, as compared to the case where there is no haptic feedback.

At this time, in the shaking operation, the left and right motion (yaw) of the wrist generally corresponds to the horizontal motion of the pointer 104 on the screen 101 and the up and down motion (pitch) corresponds to the vertical motion of the pointer 104 on the screen 101. Although FIG. 1 shows an example of shaking in a main axis direction, all shaking operations in the main axis direction as well as left, right, up, down, diagonal directions are possible.

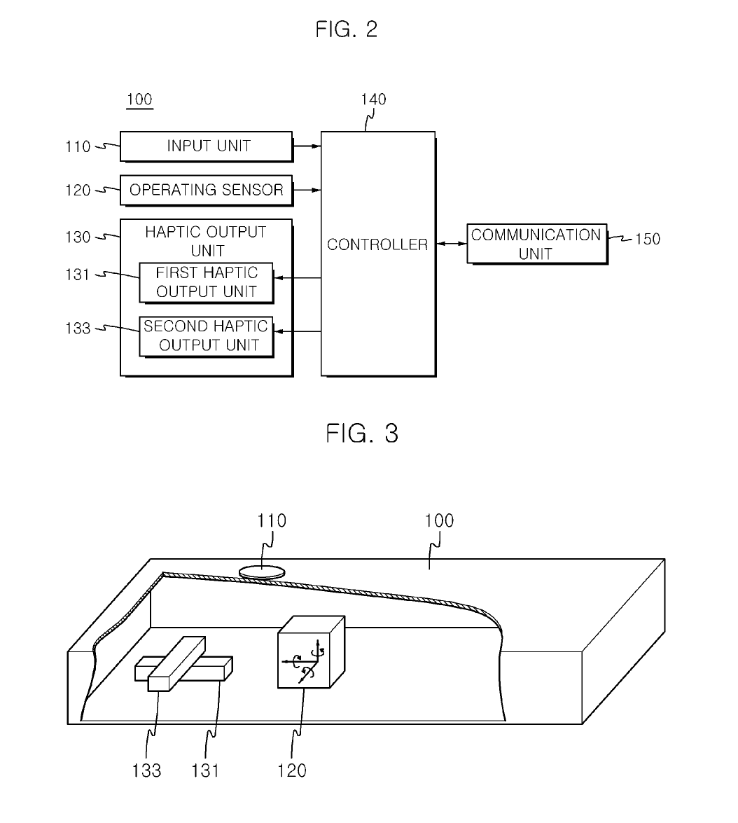

FIG. 2 is a block diagram showing a configuration of the pointing unit 100 of the motion based pointing apparatus providing haptic feedback according to the present invention and FIG. 3 is a perspective view showing a configuration of the pointing unit 100.

Referring to FIGS. 2 and 3, the pointing unit 100 according to the present invention includes an input unit 110, an operating sensor 120, a haptic output unit 130, a controller 140, and a communication unit 150.

The input unit 110 is implemented in a plurality of key button forms and replaces functions such as left and right clicks, scroll, etc., of a mouse or is used as a button for inputting various instructions when being used as a remote controller, etc.

The operating sensor 120 includes an inertia sensor that measures the motion of user's wrist and the motion of user's hand. The inertia sensor includes an angular speed sensor that measures an angular speed in a 3-axis direction and an acceleration sensor that measures acceleration in a 3-axis direction.

At this time, when the angular speed sensor uses only up, down, left, and right motions to control the position of the pointer, only the two-axis direction is used, but the acceleration sensor can freely design 1-axis to 3-axis according to a purpose.

The haptic output unit 130 transmits haptic information to the user based on a linear vibrator. At this time, the haptic output unit 130 can be provided in plural.

The haptic output unit 130 includes a first haptic output unit 131 that outputs the haptic information on the motion in a main axis direction of the pointing unit 100 and a second haptic output unit 133 that is disposed in a vertical direction to the first haptic output unit 131 and outputs the haptic information on the horizontal motion of the pointing unit 100.

In the first haptic output unit 131, the linear vibrator, which is disposed in a longitudinal direction of the pointing unit 100, generates collision or vibration at both ends in the longitudinal direction of the pointing unit 100.

Preferably, the linear vibrator of the first output unit 131 is disposed to be maximally closed to a place where an index finger contacts a middle finger, at the time the user grips the pointing unit 100 with his/her own hand.

In the second haptic output unit 133, the linear vibrator generates the collision or the vibration at both ends in a horizontal direction of the pointing unit 100.

Of course, the embodiment of the present invention shows the haptic output unit 130 that is configured to include the first haptic output unit 131 and the second haptic output unit 133 and is not limited thereto. Therefore, the embodiment of the present invention can be implemented in a single haptic output unit 130 and three or more haptic output units 130.

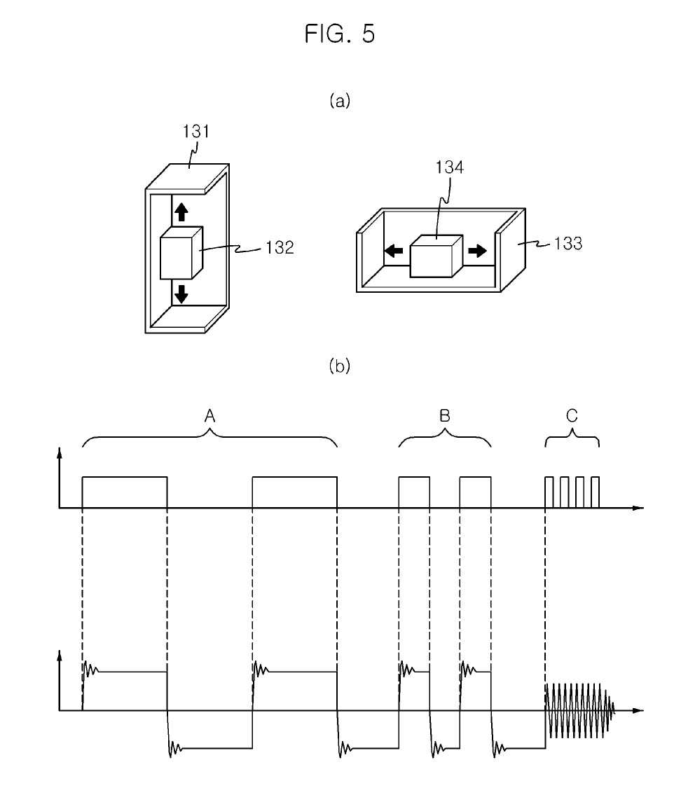

The operating principle of the linear vibrator of the haptic output unit 130 will be described with reference to FIG. 5.

The communication unit 150 communicates with the terminal unit 200 to be controlled.

The controller 140 controls the operations of the input unit 110, the operating sensor 120, the haptic output unit 130, and the communication unit 150.

Further, the controller 140 outputs the motion information sensed by the terminal unit 200 connected through the communication unit 150 when the operating sensor 120 senses the motions of the user such as the hand, wrist, arm of the user, etc.

In addition, when the controller 140 receives the haptic information corresponding to the motion information from the terminal unit 200 connected through the communication unit 150, it outputs the received haptic information to the haptic output unit 130. Thereby, the haptic output unit 130 generates the collision or the vibration according to the haptic information from the controller 140.

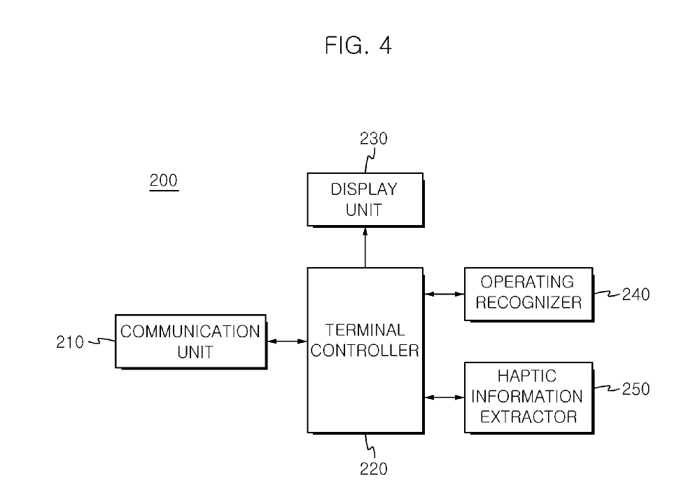

FIG. 4 is a block diagram showing a configuration of a terminal unit 200 of the motion based pointing apparatus providing haptic feedback according to the present invention.

As shown in FIG. 4, the terminal unit 200 according to the present invention includes a communication unit 210, a terminal controller 220, a display unit 230, an operating recognizer 240, and a haptic information extractor 250.

The communication unit 210 receives the motion information of the user sensed by the pointing unit 100 connected to the pointing unit 100 and the control instruction input from the user, etc. In addition, the communication unit 210 provides haptic information from the haptic information extractor 250 corresponding to the received motion information to the pointing unit 100 connected to the communication unit 210.

The display unit 230 displays the operating screen, the pointer, etc., according to the control signals from the pointing unit 100 connected through the communication unit 210.

The operating recognizer 240 determines the control instructions, which are input from the user, from the signals received through the communication unit 210. In addition, the operating recognizer 240 recognizes the operation of the user based on the motion information of the user received through the communication unit 210.

At this time, the terminal controller 220 controls the motion of the pointer, etc., displayed on the display unit 230 corresponding to the operation recognized by the operating recognizer 240.

In addition, the terminal controller 220 transmits the operating information recognized by the operating recognizer 240 to the haptic information extractor 250. The haptic information extractor 250 extracts the haptic information corresponding to the operating information transmitted from the terminal controller 220. At this time, the haptic information extractor 250 outputs the haptic information through a haptic output engine.

The haptic information output by the haptic information extractor 250 is transmitted to the communication unit 210 by the terminal controller 220, which is in turn transmitted to the pointing unit 100.

FIG. 5 is an exemplified diagram referenced for explaining an operating principle of the linear vibrator.

First, FIG. 5(a) shows the linear vibrator, wherein the linear vibrator uses a magnetic field to linearly move a mass body.

At this time, the linear vibrator disposed in the up and down direction generates vibration in the up and down direction of the pointing unit 100 according to the motion of the mass body and the linear vibrator disposed in the left and right directions generates vibration the left or right directions of the pointing unit 100 according to the motion of the mass body.

The linear vibrator of the present invention is quicker in reaction speed than an eccentric rotational vibrator used when generating the existing haptic stimulation as well as being subjected to a smaller influence of inertia to rapidly stop the operation after an electric signal is interrupted, making it possible to transmit instant and short haptic information.

FIG. 5(b) shows a digital signal and FIG. 5(c) shows the vibration signal of the linear vibrator generated corresponding to the digital signal of FIG. 5(b).

Referring to FIG. 5(b) and FIG. 5(c), when the linear vibrator is generally controlled by using HIGH and LOW digital signals, such as in the case of FIG. 5(a), the mass body moves to one side when the HIGH signal is supplied and the mass body moves to the opposite side when the LOW signal is supplied.

At this time, the linear vibrator generates the collision by colliding the mass body with one side such that the signal is instantly changed in the case of the digital signal.

In addition, the linear vibrator is subjected less to the influence of inertia remaining even after the electric signal stops. In other words, as in the case of B, the interference between the current signal and the previous signals is relatively small even in the case when the period of the signal is short.

In addition, the linear vibrator is vibrated without the mass body colliding with a wall surface when the generation period of the signal is very short as shown in FIG. 5(c).

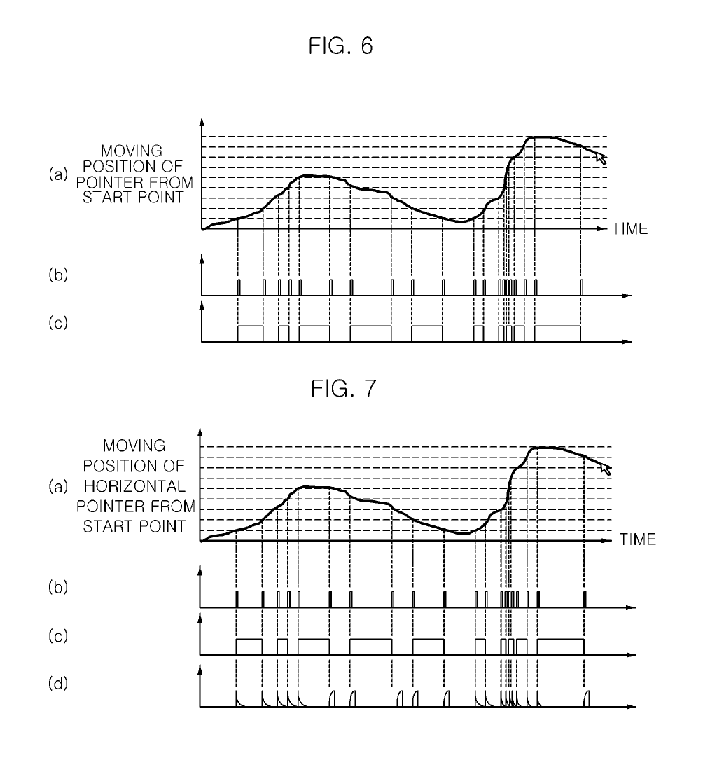

FIGS. 6 to 19 are diagrams referenced for explaining the operation of the motion based pointing unit 100 providing haptic feedback according to the present invention.

FIG. 6 shows an operating example providing haptic feedback using the linear vibrator of the first haptic output unit 131 while the point displayed on the screen of the terminal unit 200 moves by the pointing unit 100 according to the present invention.

As shown in FIG. 6(a), when the pointer displayed on the screen of the terminal unit 200 continuously moves from a starting point, the first haptic output unit 131 outputs the haptic information corresponding to the degree of the motion of the user's hand or wrist, etc., due to motion of the pointing unit 100 to the user.

A haptic information extractor 250 of the terminal unit 200 outputs the haptic information whenever the position of the pointer is generated exceeding specific variation.

Therefore, the user determines the position of the pointer based on visual information and haptic information, thereby making it possible to precisely and conveniently operate the position of the pointer.

In addition, the haptic information extractor 250 of the terminal unit 200 controls the haptic output generation frequency in proportion to the moving speed of the pointer, such that the user can intuitively experience the moving speed of the pointer.

The haptic information extractor 250 of the terminal unit 200 can repeatedly output the short HIGH/LOW signal at the time of generating the haptic output as shown in FIG. 6(b). At this time, the linear vibrator of the pointing unit 100 instantly generates the reciprocal collision of the mass body in two ways according to the haptic information from the terminal unit 200.

In this case, the position of the mass body is returned to an original position even after the operation is performed once.

Meanwhile, the haptic information extractor 250 of the terminal unit 200 can output the signal to generate the LOW or HIGH signal once, which is opposite to the previous state, at the time of generating the haptic output as shown in FIG. 6(c). In this case, it can reduce energy consumption while performing the a quicker reaction.

In other words, the terminal unit 200 mainly generates the events whenever the motion of the pointer is generated, such that it moves the position of the object on the screen using the pointing unit 100 or generates the double-surface collision of the linear vibrator whenever the motion event of the pointer is generated during drawing a picture or writing.

Further, when in the motion of the pointer as well as in the pointing unit 100 itself, the wrist is rotated by unit orientation or the position of the hand is changed by a unit position, such that the haptic output is generated; thus operability can be increased.

FIG. 7 shows operating examples providing haptic feedback using the linear vibrator of the second haptic output unit 133 while the point displayed on the screen of the terminal unit 200 correspondingly moves by the pointing unit 100 according to the present invention.

FIG. 7(a) is a graph showing that the pointer continuously moving in a horizontal direction from a starting point can move to some degree in any direction.

As such, when the pointer continuously moves in the horizontal direction, the haptic information extractor 250 of the terminal unit 200 outputs the corresponding haptic information. At this time, the second haptic output unit 133 responds to the haptic information from the terminal unit 200 to move the vibrating body of the linear vibrator, thereby generating collision.

The linear vibrator of the second haptic output unit 133 is arranged to correspond to the left and right rotation of the user's wrist or the left and right motion of the user's hand, such that it generates the collision as described in FIG. 6 whenever the position of the pointer displayed on the screen of the terminal unit 200 interworks with the pointing unit 100, which is generated exceeding specific variation.

In other words, as shown in FIG. 7(b), the linear vibrator of the second haptic output unit 133 repeats the short HIGH/LOW signal at the timing of generating the haptic output to instantly generate the reciprocal collision in two ways or as shown in FIG. 7(c), generate the collision according to the signal where the LOW or HIGH signal that is opposite to the previous state at the timing of generating the haptic output is generated once.

Meanwhile, in order to transmit the directivity on which the linear vibrator of the second haptic output 133 moves in any direction, the linear vibrator of the second haptic output unit 133 responds to the haptic generating signal to generate the collision as shown in FIG. 7(d).

In other words, when the pointer moves right, the haptic information extractor 250 of the terminal unit 200 instantly applies the HIGH signal to the second haptic output unit 133 and then, outputs a gradually decreased signal, such that the mass body collides right but when the mass body is returned left, it is slowly returned not to generate the collision. Meanwhile, when the pointer moves left, the haptic information extractor 250 of the terminal unit 200 applies the gradually increased HIGH signal to the second haptic output unit 133 and then supplies the signal instantly changed to LOW to move the mass body right without generating the collision but in order to collide it left.

In this case, when the gradually moving control is made at a short time (generally, 20 msec or so) so as not to generate the collision, the user does not feel the time difference, instead immediately feels the left or right collision. Therefore, the method shown in FIG. 7(d) intuitively notifies the user that the haptic information moves in some direction.

Although the above-mentioned method is not shown in the present invention, the linear vibrators of the haptic output unit 130 are disposed up and down and vertically, such that they can be applied to the up and down motion.

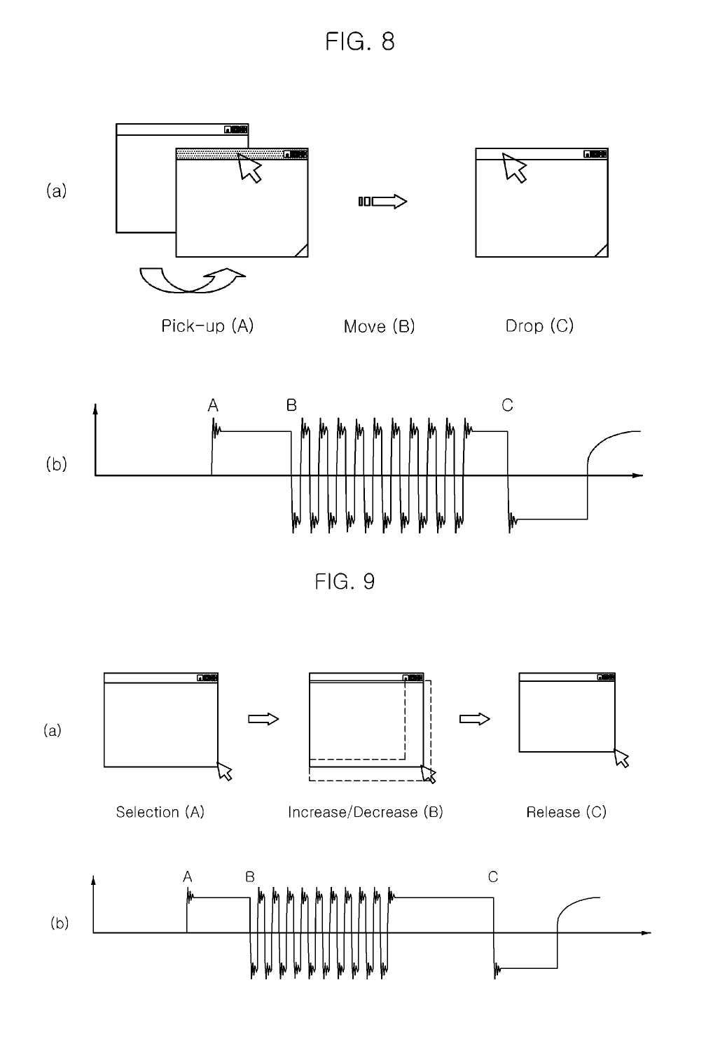

FIGS. 8 to 15 are diagrams showing an embodiment of providing haptic feedback according to the motion of the pointer corresponding to the operating screen displayed on the screen of the terminal unit 200.

First, FIG. 8 shows an example of providing haptic feedback during transferring the position of the screen or the icon, etc., on the screen.

FIG. 8(a) shows the operation displayed on the screen and FIG. 8(b) shows the haptic output signal according to the operation of FIG. 8(a).

As shown in FIG. 8(a), the position of the screen connected to the terminal unit 200 is displayed with an icon representing a file, a shortcut, a folder, etc., or an opened window such that it can be selectively displayed through the operation of the pointer.

When the button for selecting the window displayed on the screen is operated in the pointing unit 100, the haptic information extractor 250 of the terminal unit 200 outputs a signal that collides the linear vibrator of the haptic output unit 130 of the pointing unit 100 to one side of the upper portion once in order to haptically notify that the window is selected as in (A). Therefore, the haptic output unit 130 generates the collision of the linear vibrator according to the input signal.

In addition, when the user's hand moves while gripping the pointing unit 100 or the user's wrist in order to move the selected window, the operating recognizer 240 of the terminal unit 200 senses the motion of the pointing unit 100 to move the pointer on the screen as in (B). Therefore, the haptic information extractor 250 outputs the haptic information in proportion to the moving speed and the haptic output unit 130 of the pointing unit 100 uses the linear vibrator according to the haptic information to provide two-way haptic feedback.

In addition, when transferring the window to the desired position using the pointing unit 100 as in (c) and then, operating the button releasing the selection of the pointer, the terminal unit 200 outputs the haptic information that collides the linear vibrator build therein to a down side to reproduce the feeling that the selected window is separated. Therefore, the linear vibrator of the haptic output unit 130 generates the down collision according to the output haptic information.

At this time, the haptic output unit 130 can selectively operate any one of the first haptic output unit 131 and the second haptic output unit 133 according to the moving position and direction of the pointer.

As such, when using the haptic feedback of the pointing unit 100 according to the present invention, it can intuitively notify to the user whether the object is selected or the object moves.

FIG. 9 shows examples of providing the haptic feedback during controlling the size of the window. FIG. 9(a) shows the operation displayed on the screen and FIG. 9(b) shows the haptic output signal according to the operation of FIG. 9(a).

When selecting vertexes of corners of the window or an outer boundary position of the window by operating the button of the pointing unit 100 in order to control the size of the window as in (A), the haptic information extractor 250 outputs the haptic information that collides the linear vibrator upward. At this time, the linear vibrator collides the vibrating body upward, thereby reproducing the feeling that window is likely to attach to the pointing device 100.

In addition, during the movement of the pointing unit 100 in order to change the size of the window selected as in (B), the haptic stimulation is output whenever the unit size is increased or decreased.

Further, when the size of the window is changed by the desired size as in (C) and the button releasing the selection of the window is then operated, the mass body of the linear vibration collides downward, thereby reproducing the feeling that the instant window is likely to separate.

If necessary, the operation completes and then, the mass body of the linear vibration gradually moves, such that the user may not feel the haptic collision.

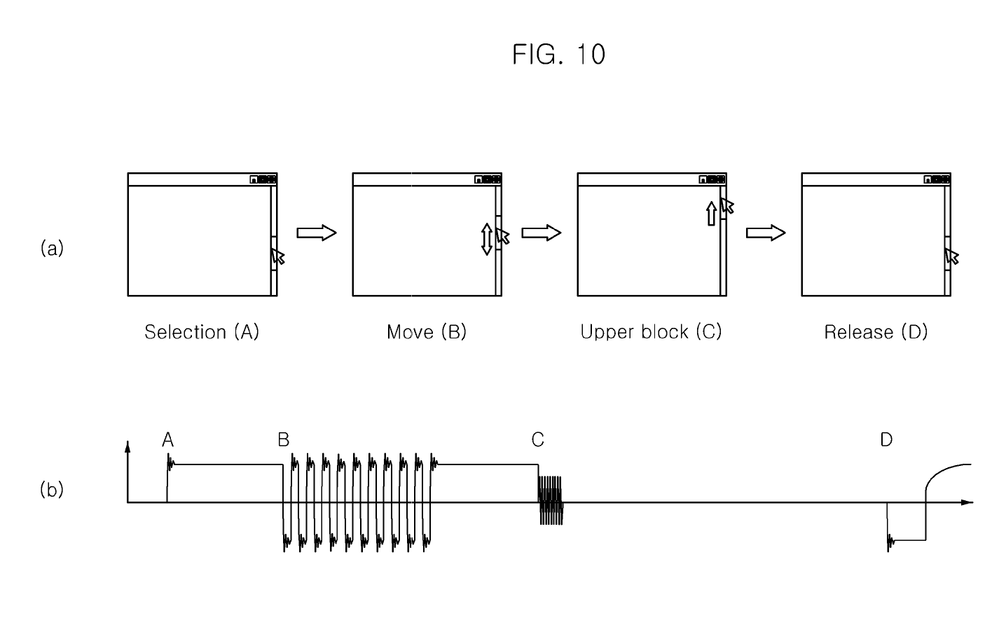

FIG. 10 shows examples that provide the haptic feedback during operating the scroll bar of the window. FIG. 10(a) shows an operation displayed on the screen and FIG. 10(b) shows the haptic output signal according to the operation of FIG. 10(a).

Referring to FIG. 10, when the pointer selects the scroll bar using the pointing unit 100 as in (A), the upper side collision is generated by the linear vibrator of the haptic output unit 130, thereby reproducing the feeling that the instant pointer is attaching to the scroll bar.

Further, while moving the selected scroll bar by moving the pointing unit 100 as in (B), the two-way haptic feedback is provided by the linear vibrator of the haptic output unit 130 through the unit motion of the pointer, such that the user feels the haptic stimulation.

Meanwhile, when the scroll bar reaches the limitation that it can move upward or downward, the linear vibrator is controlled as a very short signal to instantly generate a short and strong vibration, thereby providing the haptic feedback notifying that the scroll bar reaches the top or bottom position.

After the position of the scroll bar is changed as much as is desired, the lower side collision is generated using the linear vibrator of the haptic output unit 130 as in (D), thereby reproducing the feeling that the scroll bar is likely to separate from the pointer.

Herein, since the scroll bar is operated vertically, the linear vibrator is disposed in a vertical direction, thereby making it possible for the haptic feedback to notify that the scroll bar moves in a specific direction as described in FIG. 7(d).

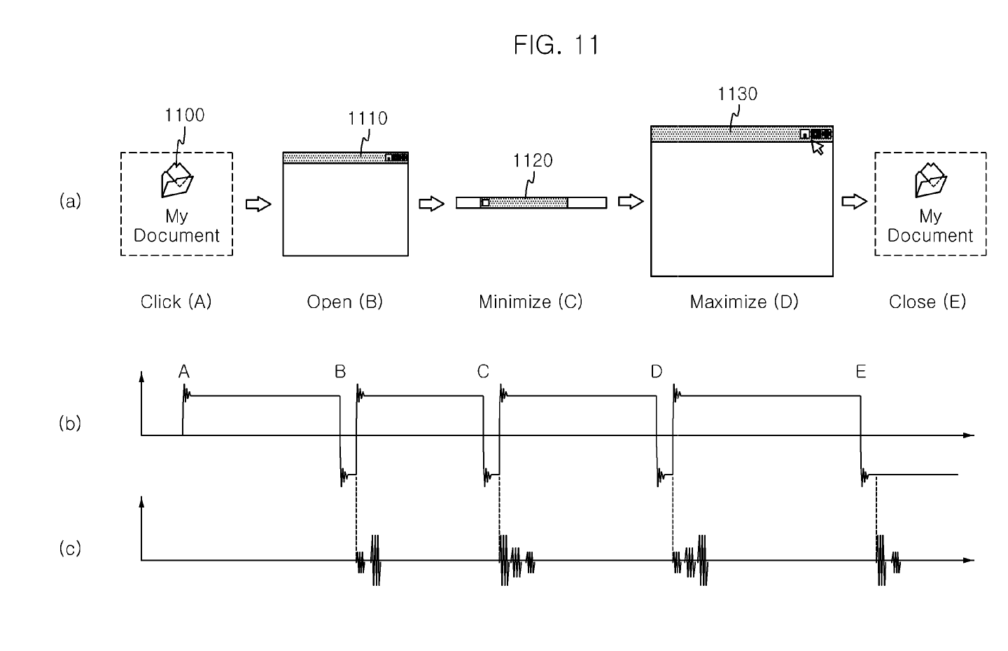

FIG. 11 is an example that provide the haptic feedback according to the operation of maximizing or minimizing the size of the window. FIG. 11(a) shows the operation displayed on the screen, FIGS. 11(b) and 11(c) show the haptic output signal according to the operation of FIG. 11(a).

Referring to FIG. 11, when selecting and executing the specific icon using the pointing unit 100 as in (A), the vibrating body of the linear vibrator collides upward to be met with the operation of the user in order to reproduce the feeling of clicking icons.

Thereafter, when the window is opened as in (B), the linear vibrator of the haptic output unit 130 collides downward and then collides upward, thereby reproducing the feeling that the window is opened while opening up.

Further, when the button for minimizing or maximizing the window using the pointing unit 100 as in (C) or (D) is operated, the collision is instantly generated by the linear vibrator of the haptic output unit 130 in order to reproduce the feeling of pressing the button. Then, the collision is generated again by the linear vibrator in order to transmit the feeling that the window is minimized or maximized.

In addition, when the button is operated to close the window using the pointing unit 100 as in (E), the lower side collision is generated using the linear vibrator of the haptic output unit 130, thereby reproducing the feeling that the window is closed.

At this time, as shown in FIG. 11(c), the vibration is instantly generated for each of B), (C), (D), and (E), such that it is possible to transmit the haptic feeling to the user.

The embodiment of the haptic feedback generated for each of (B), (C), (D), and (E) is not limited to the above example, but many be implemented in various forms.

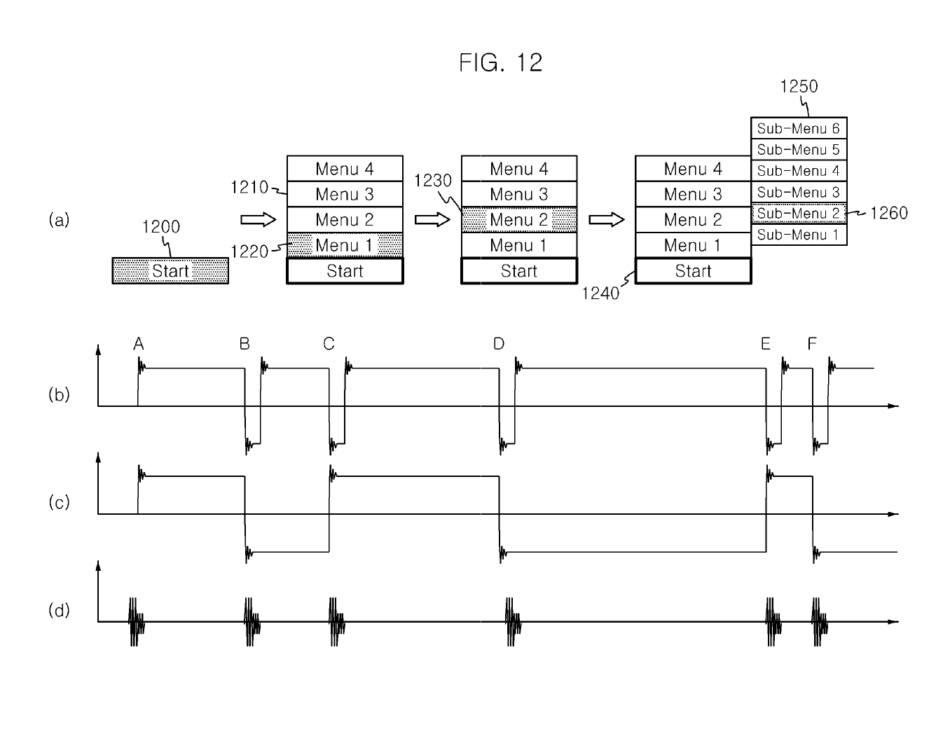

FIG. 12 shows an example that provide the haptic feedback during the movement of a menu and the operation of a popup menu. FIG. 12(a) shows the operation displayed on the screen and FIG. 12(b) to FIG. 12(d) show the haptic output signal according to the operation of FIG. 12A.

In FIG. 12, when the pointer moves the menu or the menu list using the pointing unit 100, it can be accurately understood whether the menu is changed or the pointer is located on any menu by using the haptic feedback. The embodiment of FIG. 12 can be used for the operation of the popup menu on the graphic user interface, the page movement using the popup menu upon the presentation, or the channel movement through the menu when viewing media such as TV, etc.

In the case of FIG. 12(b), when the first starting menu is selected, the upper side collision is generated by the linear vibrator of the haptic output unit 130 as in A, when a new menu list popup is executed, the reciprocal collision is generated using the linear vibrator of the haptic output unit 130 as in B. Further, in the new menu list popup, when the pointer moves to ‘Menu1’ or ‘Menu2’, the reciprocal collision is generated using the linear vibrator of the haptic output unit 130 as in C and D.

Thereafter, when ‘Menu2’ is selected to execute the new popup menu and the pointer moves to the new menu ‘Sub-Menu2’, the reciprocal collision is generated using the linear vibrator of the haptic output unit 130 as in E and F, respectively.

In FIG. 12(b), when the reciprocal collision is generated in two ways every time the haptic is output and in FIG. 12(c), when events such as A, B, C, D, E, F are generated, the collisions in the upper side direction and the lower side direction are alternately generated by using the linear vibrator of the haptic output unit 130.

Meanwhile, in FIG. 12(d), when the events such as A, B, C, D, E, F are generated, the predetermined vibration is generated using the linear vibrator of the haptic output unit 130 every time the event is generated, thereby making it possible for the user to easily recognize the event generation.

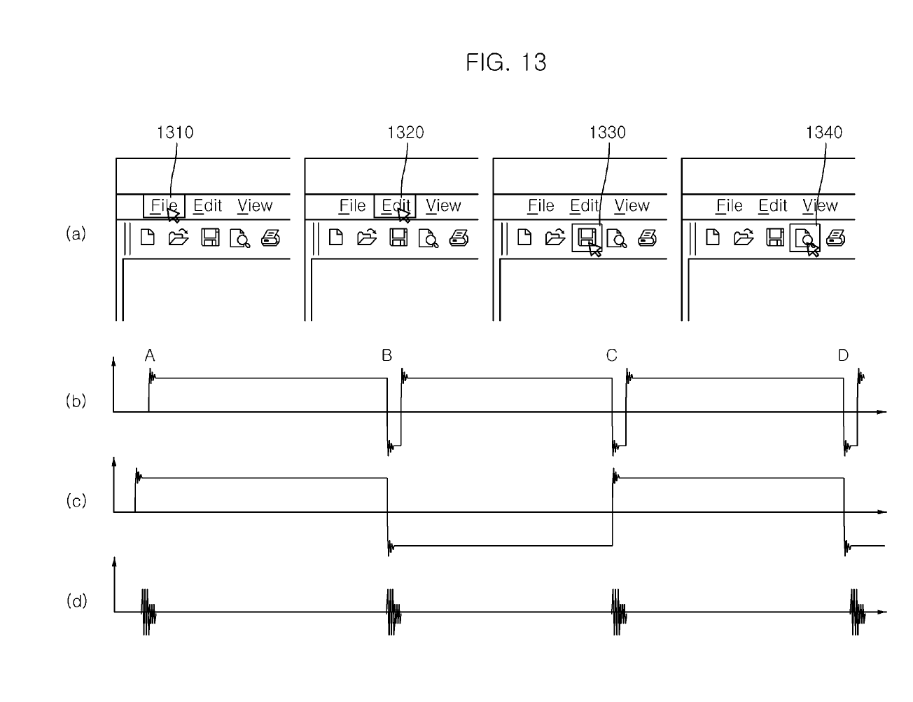

FIG. 13 shows examples that provide the haptic feedback when the pointer passes through the menu and the icon. FIG. 13(a) shows the operation displayed on the screen, FIG. 13(b), FIG. 13(c) and FIG. 13(d) show the haptic output signal according to the operation of FIG. 13(a).

As shown in FIG. 13, when the pointer is moved according the motion of the hand or the wrist gripping the pointing unit 100, the haptic feedback is provided when the pointer passes through the boundary of the menu or the icon. In this case, the user can intuitively understand whether his and her pointer is located at which position.

In FIG. 13A, the pointer sequentially moves above ‘File’ menu, ‘Edit’ menu, ‘storage’ icon, and ‘preview’ icon. At this time, when the pointer passes through the boundary of ‘File’ menu, ‘Edit’ menu, ‘storage’ icon, and ‘preview’ icon, the haptic information output unit generates the events such as A, B, C, and D.

In FIG. 13(b), when the events such as A, B, C, and D are generated, the reciprocal collision is generated in two ways using the linear vibrator of the haptic output unit 130.

In FIG. 13(c), when the events such as A, B, C, and D are generated, the upper side collision and the lower side collision is alternately generated using the linear vibrator of the haptic output unit 130.

Meanwhile, in FIG. 13(d), when the events such as A, B, C, D, E, F are generated, the predetermined vibration is changed using the linear vibrator of the haptic output unit 130 every time the event is generated, thereby making it possible for the user to easily recognize the event generation.

Although FIG. 13 shows an example that provide the haptic feedback only when the pointer enters the boundary of the menu or the icon, the haptic feedback can be provided when the pointer enters the boundary of the menu or the icon and comes out of the boundary thereof.

The embodiment of FIG. 13 can be used as a method of providing the haptic feedback at the moment that the mouse is located above a hyperlink area upon searching website, etc.

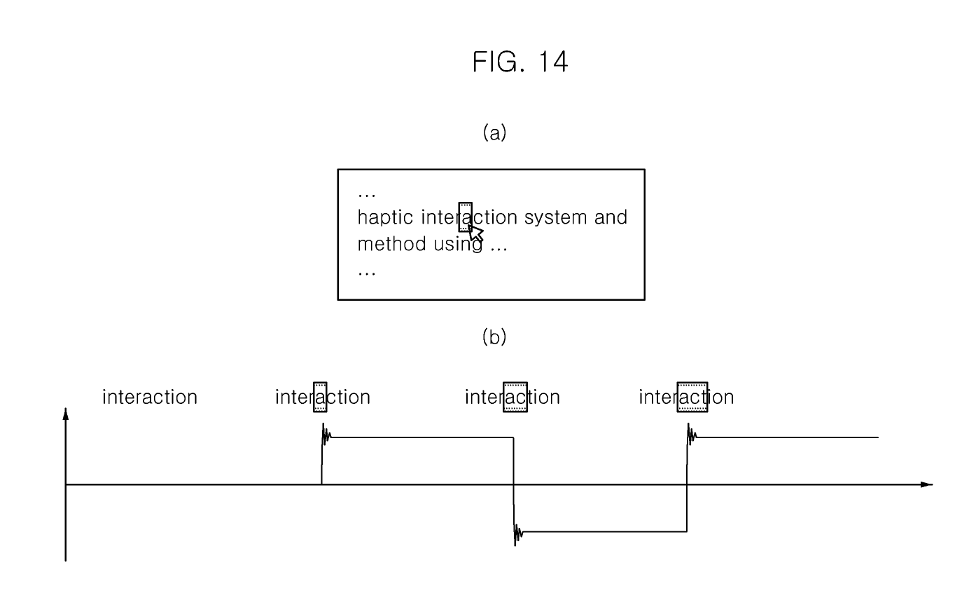

FIG. 14 shows an example of providing the haptic feedback while selecting several letters. FIG. 14(a) shows the operation displayed on the screen and FIG. 14(b) shows the haptic output signal according to the operation of FIG. 14(a).

When the embodiment shown in FIG. 14 selects several letters using the operation of the pointer, the position of the pointer is not precisely operated, such that it is difficult to accurately select several letters. As a result, in order to solve the problem, the haptic output is generated whenever the number of selected letters is increased one by one, thereby making it possible to accurately select letters.

In other words, in the state where a sentence as shown in FIG. 14(a) is displayed on the screen, when selecting ‘act’ using the pointer, ‘a’ letter is selected by operating the selection button and then, moving the pointer to generate the collision in one direction using the linear vibrator of the haptic output unit 130 and thereafter, when ‘c’ is selected, the collision is generated in another direction using the linear vibrator of the haptic output unit 130. Likewise, when ‘t’ is selected, the collision is generated again in an opposite direction using the linear vibrator of the haptic output unit 130.

As such, when a plurality of letters are selected using the pointer, the pointing unit generates the collision in an opposite direction using the linear vibrator of the haptic output unit 130 whenever letters are additionally selected one by one.

As described above, the pointing unit 100 generates the reciprocal collision in two ways using the linear vibrator of the haptic output unit 130 whenever letters are selected or generates predetermined vibration, such that the user can easily recognize the event generation.

Therefore, the user can intuitively feel through tactile sense by selecting letters one by one.

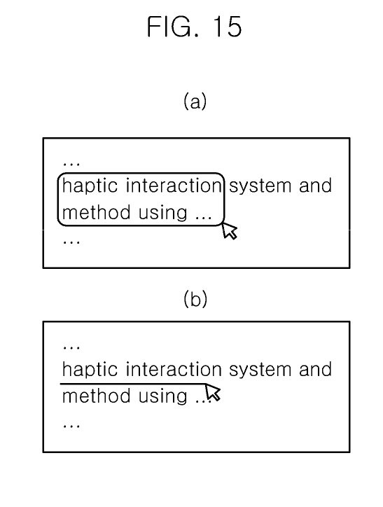

In addition, when as shown in FIG. 15(a), a predetermined letter area is selected or as shown in FIG. 15(b), an underline is drawn, the pointing unit 100 generates the collision in two ways or one way using the linear vibrator of the haptic output unit 130 whenever the pointing unit 100 selects letters or generates predetermined vibration, as described in the foregoing embodiments whenever the unit area selected according to the movement of the pointer is changed or the underlined unit length is changed, thereby making it possible for the user to easily recognize the event generation.

The embodiment of FIG. 14 and FIG. 15 can provide the haptic feedback whenever the number of letters selected by the pointer is decreased and can apply the same technology on a text viewer or a webpage viewer.

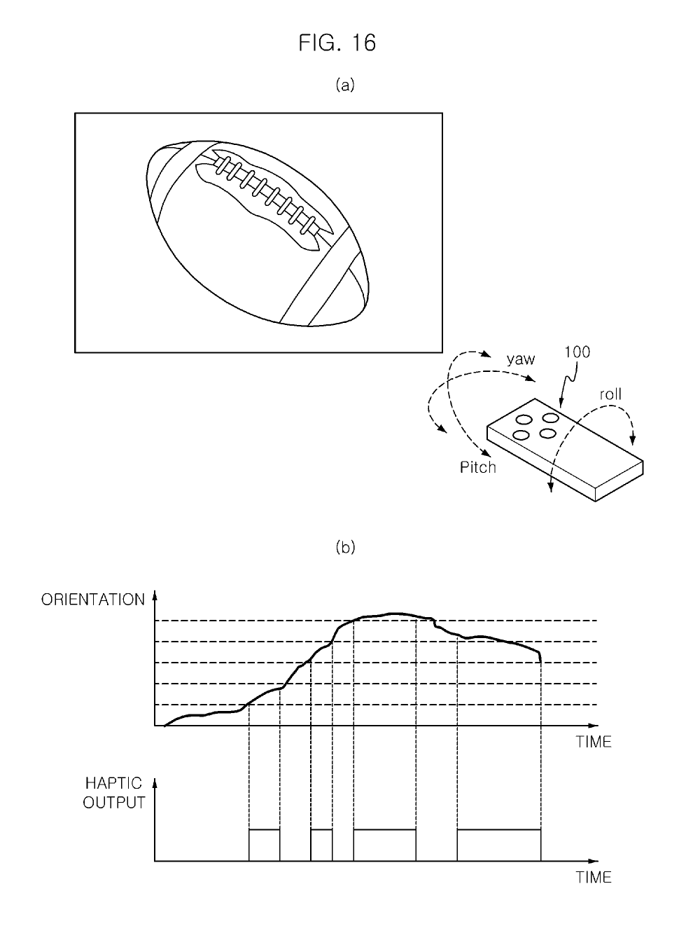

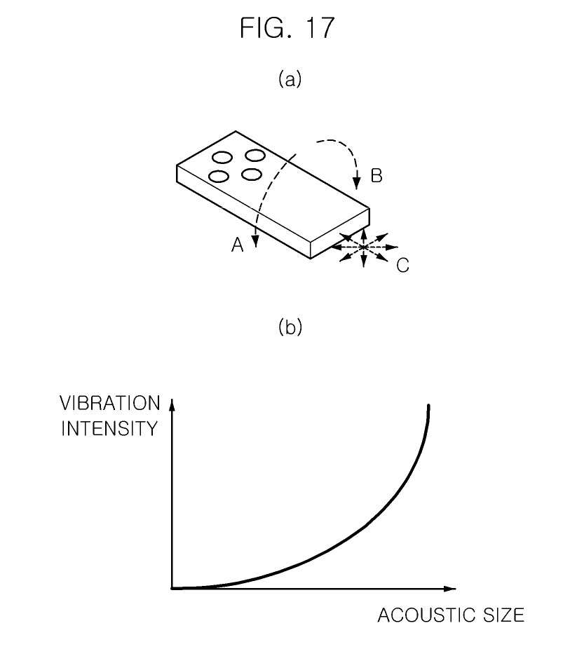

FIG. 16 shows an example that provide the haptic feedback while a posture of a three-dimensional object displayed on the screen is operated using the pointing unit 100 according to the present invention.

FIG. 16(a) shows an operation of the three-dimensional object displayed on the screen using the pointing unit 100 according to the present invention and FIG. 16(b) shows a graph according to the motion of the three-dimensional object according to the motion of the pointing unit 100 and the haptic output signal corresponding thereto.

In particular, FIG. 16(b) is a graph showing a change in the orientation of the three-dimensional object displayed on the screen according to the motion of the pointing unit 100 and the operational recognizer 240 of the terminal unit 200 matches the change in the three-axis orientation of the pointing unit 100 to the change in the orientation of the three-dimensional object displayed on the screen. At this time, the haptic information extractor 250 monitors the change in the orientation of the three-dimensional object and when the change in the orientation from the starting point occurs, outputs the haptic information as shown in FIG. 16(c) whenever the orientation is changed above the unit orientation, thereby outputting the haptic output from the pointing unit 100.

At this time, the pointing unit 100 is disposed front, rear, up, down, left, and right using the three haptic output unit 130 and then, can generate the haptic output signal whenever the unit orientation is changed in each direction. Of course, when the change is generated at any orientations using only one haptic output unit 130, a simple method of performing the haptic output can be applied.

FIG. 17 shows an exemplified diagram referenced for explaining an operational method of the pointing unit 100 according to the present invention.

As shown in FIG. 17, the pointing unit 100 according to the present invention can measure the rotational rolling based on a main axis as well as measure the change shaking in a main axis direction, up, down, left and right directions and a diagonal direction. In the rotational rolling based on the main axis, the clockwise rotation may correspond to a function of turning a page to a next page in a document viewer, etc., and in the media, may correspond to the switching to a next channel.

The above-mentioned motion of the pointing unit 100 is recognized by the terminal unit 200 and generates the collision using the linear vibrator of the first haptic output unit 131 according to the haptic information extracted from the haptic information extractor 250.

In addition, when using the second haptic output unit 133, the collision is generated only in one direction (for example right direction) as shown in FIG. 7, thereby making it possible to more intuitively appreciate that a page or a channel is switched to the next page or the next channel.

Meanwhile, the counterclockwise rotation may correspond to a function of turning a page to a previous page in a document viewer, etc., and in the media, may correspond to switching to a previous channel. In this case, unlike the above-described embodiment, the collision is generated at an opposite surface using the linear vibrator of the first haptic output unit 131 or the collision is generated at a left surface of the second haptic output unit 133. At this time, the clockwise rotation and the counterclockwise rotation within 90° can be measured by an acceleration sensor that senses the change in a gravity direction, instead of an angular speed sensor.

In addition, it can likewise be applied to the operation of increasing or decreasing the acoustic size. At this time, the vibration is generated using the linear vibrator but the larger the acoustic size, the stronger the vibration is generated and the smaller the acoustic size, the weaker the vibration is generated, thereby making it possible to more intuitively appreciate the change in the sound size. Meanwhile, when the pointing unit 100 shakes in a main axis direction, the shaking direction is recognized to generate the collision in the direction shaking through the first haptic output unit 131, thereby making it possible to provide the haptic feedback such as the actual feeling of physically clicking.

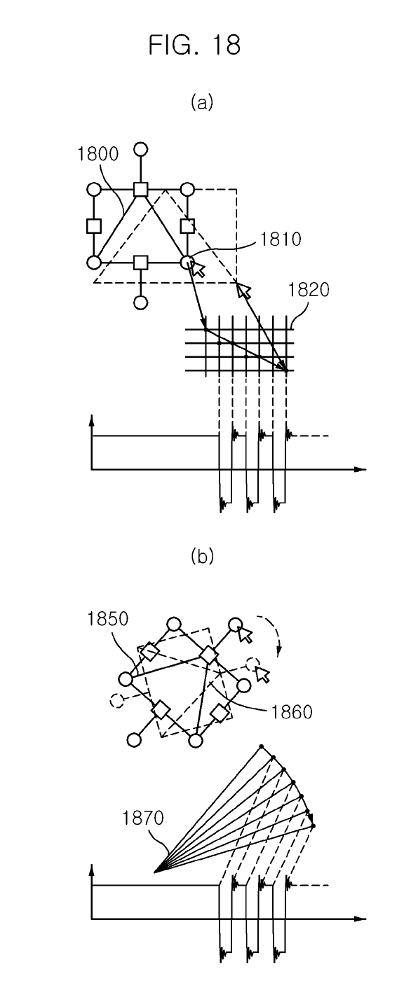

FIG. 18 shows an example that provides the haptic feedback while a figure work is performed using the pointing unit 100 according to the present invention.

FIG. 18(a) shows the operation of changing a size of a figure using the pointer. Likewise the embodiment of FIG. 9, the haptic output unit 130 may generate the reciprocal collision or the collision to one surface using the linear vibrator whenever the figure is larger or smaller than a unit coordinate.

Meanwhile, FIG. 18(b) shows an operation of rotating the figure using the pointer. In FIG. 18(b), when rotating the figure using the pointer, the haptic output unit 130 may generate the reciprocal collision or the collision to one surface using the linear vibrator whenever it is rotated at unit orientation or more.

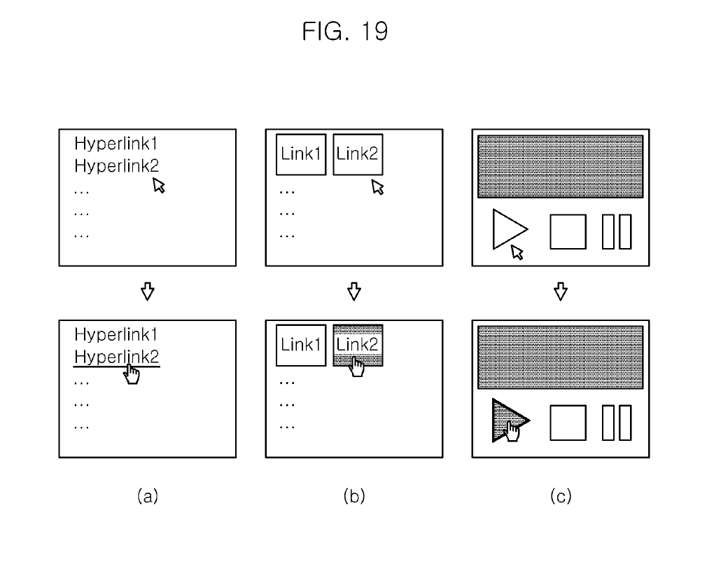

FIG. 19 shows an example that provides the haptic feedback according to the usable state such as the menu or the icon, etc., where the pointer is positioned when operating the pointer using the pointing unit 100 according to the present invention.

FIG. 19, when generally using Internet or various programs, the pointer moves to various links that means a hyperlink, screen switching, execution, etc., such that the pointer is changed to a hand shape. This notifies the state where the corresponding links can be connected to each other.

Therefore, in the present invention, when operating the pointer using the pointing unit 100, the haptic feedback is provided in the state when the links at a point where the pointer is positioned can be connected to each other or the state when the icon, etc., can be executed.

For example, as shown in FIG. 19(a), when the pointer moves to HyperLink 2, the shape of the link is changed as in ‘HyperLink2’ and the shape of the pointer is changed. At this time, the haptic information extractor 250 of the terminal unit 200 extracts the haptic information, thereby outputting the corresponding haptic signal from the pointing unit 100.

In addition, as shown in FIG. 19(b), when changing the shape and the color by moving the pointer to ‘Link2’, the haptic information extractor 250 of the terminal unit 200 extracts the haptic information, thereby outputting the corresponding haptic signal from the pointing unit 100.

Further, as shown in FIG. 19(c), when changing the shape and the color of the reproducing button icon by moving the pointer to the reproducing button icon, the haptic information extractor 250 of the terminal unit 200 extracts the haptic information, thereby outputting the corresponding haptic signal from the pointing unit 100.

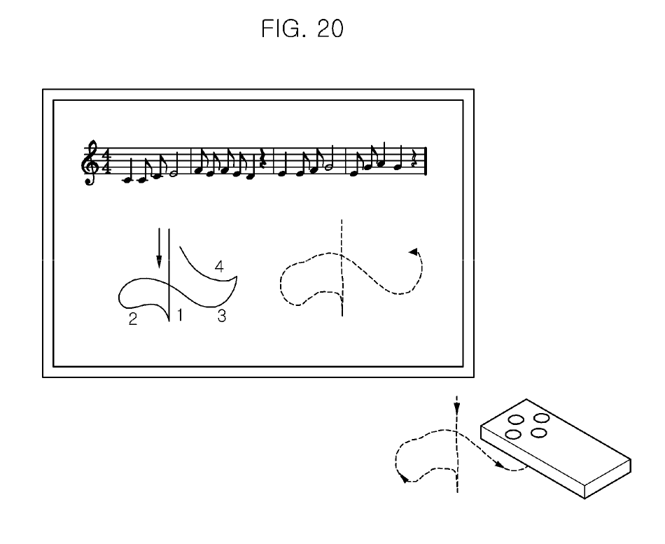

Meanwhile, FIG. 20 shows an example that provides the haptic feedback according to the motion of the pointer when operating the pointer using the pointing unit 100 according to the present invention, and more specifically, shows an example that provides the haptic feedback when the directing motion is conducted using the pointing unit 100 according to the present invention.

As shown in FIG. 20, the user grips the pointing unit 100, such that he/she can conduct the same motion as directing rhythm in the air. At this time, the terminal unit 200 controls the motion of the pointer displayed on the screen according to the motion of the pointing unit 100 and outputs the haptic information corresponding thereto. Therefore, the pointing unit 100 generates the haptic stimulation corresponding to the directing motion, thereby making it possible to obtain an effect of training the directing exercise.

In particular, the directing shape is displayed on the screen as a picture, corresponding to the position of the pointer on the screen. Further, when a specific rhythm starts, the short vibration or collision may be instantly generated within 100 msec. In this case, for example, a very excellent rhythm and direction training system in view of a learning effect by accompanying all the visual and tactile motions of an arm can be provided.

The motion based pointing device providing the haptic feedback according to the present invention controls the pointers on the screen connected to the terminal by using the change in orientation measured according to the motion of the user's wrist left, right, up, and down, such that it can be used as the pointing device replacing the existing mouse and as the remote controller for controlling TV or acoustic devices, etc.

The operations of the present invention configured as described above will now be described.

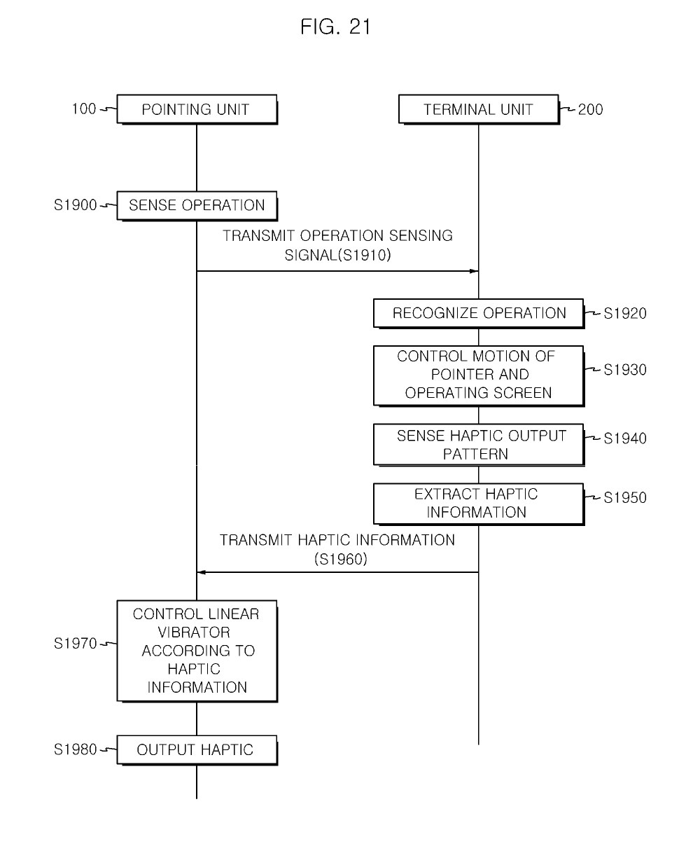

FIG. 21 is a flow chart showing an operational flow of a control method of the motion based pointing apparatus providing haptic feedback according to the present invention.

Referring to FIG. 21, the user grips the pointing unit 100 by his/her own hand to perform the specific motion, such that the pointing unit 100 senses the operation according to the motion of the user (S1900) and transmits the operational sensing signal by the terminal unit 200 (S1910).

The terminal unit 200 recognizes the operation or control instruction of the pointing unit 100 from the operational sensing signal received in step ‘S1910’ (S1920). Thereafter, the terminal unit 200 controls the motion of the pointer displayed on the screen corresponding to the operation or control instruction recognized at step ‘S1920’ and controls the corresponding operational screen (S1930).

In addition, the terminal unit 200 senses the haptic output pattern based on the motion of the pointer displayed on the screen and the corresponding screen change (S1940) and extracts the corresponding haptic information (S1950).

The terminal unit 200 transmits the haptic information extracted at step ‘S1950’ to the pointing unit 100 (S1960).

Meanwhile, the pointing unit 100 receiving the haptic information from the terminal unit 200 controls the linear vibrator according to the received haptic information and outputs the haptic (S1970 and S1980).

As described above, the motion based pointing device providing haptic feedback and the control method thereof according to the present invention is not limited to the configuration and method of the embodiments described as above, but the embodiments may be configured by selectively combining all the embodiments or some of the embodiments so that various modifications can be made.

What is claimed is:

1. A motion based pointing apparatus providing haptic feedback, comprising:
a pointing unit that includes an operating sensor sensing a motion of a user and a haptic output unit providing haptic feedback to the user in a major axis direction or left and right directions; and
a terminal unit that operates pointers displayed on a screen from the motion of the user sensed by the pointing unit and outputs haptic information corresponding to a change in the screen due to the motion of the pointer and the operation of the pointer to the pointing unit,
wherein the haptic output unit includes one or more linear vibrator that generates collision or vibration in at least one of up, down, left, right, front, and rear directions according to the haptic information output from the terminal unit.

2. The motion based pointing apparatus providing haptic feedback according to claim 1, wherein the haptic output unit collides the vibrating body of the linear vibrator or generates the vibration in one way or two ways.

3. The motion based pointing apparatus providing haptic feedback according to claim 2, wherein the haptic output unit generates short vibration or vibrations that are getting stronger or weaker, at the time the vibration is generated.

4. The motion based pointing apparatus providing haptic feedback according to claim 1, wherein the haptic output unit collides the vibrating body of the linear vibrator in an opposite direction or generates vibration whenever the haptic information corresponding to the change in the screen due to the operation of the pointer or the motion of the pointer is output.

5. The motion based pointing apparatus providing haptic feedback according to claim 1, wherein the haptic output unit generates the collision in a direction corresponding to the motion of the pointer.

6. The motion based pointing apparatus providing haptic feedback according to claim 1, wherein the haptic output unit generates the collision or the vibration by using the vibrating bodies of two linear vibrators that are disposed to be vertical to each other in a 2-axis direction.

7. The motion based pointing apparatus providing haptic feedback according to claim 1, wherein the haptic output unit generates the collision or the vibration by using the vibrating bodies of three linear vibrators that are disposed to be vertical to each other in a 3-axis direction.

8. The motion based pointing apparatus providing haptic feedback according to claim 1, wherein the operating sensor includes an angular speed sensor that measures an angular speed in the 3-axis direction from the motion of the pointing unit and an acceleration sensor that measures acceleration in the 3-axis direction from the motion of the pointing unit.

9. The motion based pointing apparatus providing haptic feedback according to claim 1, wherein the pointing unit further includes:
an input unit that receives a control instruction from the user and;
a communication unit that transmits and receives signals to and from the terminal unit.

10. The motion based pointing apparatus providing haptic feedback according to claim 1, wherein the terminal unit includes:
an operating recognizer that recognizes coordinate positions on the screen corresponding to the motion of the user sensed by the pointing unit to output a control signal for controlling the operation of the pointer and recognizes the change in the screen according to the operation of the pointer or the motion of the pointer; and
a haptic information extractor that extracts the haptic information corresponding to the motion of the pointer or the change in the screen that are recognized by the operating recognizer.

11. The motion based pointing apparatus providing haptic feedback according to claim 10, wherein the haptic information extractor extracts the haptic information corresponding to at least one change among the position, moving distance, moving speed, moving orientation, and shape of the pointer and the screen selection or non-selection using the pointer.

12. The motion based pointing apparatus providing haptic feedback according to claim 10, wherein the haptic information extractor extracts the haptic information corresponding to at least one change among the window, menu, icon, emoticon, button, and pattern that are displayed on the screen and the shape, size, position, and orientation of an area that is selected by the pointer.

13. The motion based pointing apparatus providing haptic feedback according to claim 10, wherein the haptic information extractor extracts the haptic information according to whether the objects pointed out by the pointer on the screen can be executed.

14. The motion based pointing apparatus providing haptic feedback according to claim 1, wherein the terminal unit further includes:
a display unit that includes the screen; and
a communication unit that transmits and receives signals to and from the pointing unit.

15. A control method of a motion based pointing apparatus providing haptic feedback, comprising:
sensing a motion of a pointing unit according to a motion of a user;
outputting a control signal for controlling an operation of a pointer that is displayed on a screen corresponding to the motion of the pointing unit;
recognizing the change in the screen according to the motion of the pointer or the operation of the pointer on the screen;
outputting haptic information corresponding to the motion of the pointer or the change in the screen that are recognized at the recognizing; and
outputting haptic operation using a linear vibrator of the pointing unit according to the output haptic information.

16. The control method of a motion based pointing apparatus providing haptic feedback according to claim 15, wherein the recognizing is performed by recognizing at least one change among the position, moving distance, moving speed, moving orientation, and shape of the pointer and the screen selection or non-selection using the pointer.

17. The control method of a motion based pointing apparatus providing haptic feedback according to claim 15, wherein the recognizing is performed by recognizing at least one change among the window, menu, icon, emoticon, button, and pattern that are displayed on the screen and the shape, size, position, and orientation of an area that is selected by the pointer.

18. The control method of a motion based pointing apparatus providing haptic feedback according to claim 15, wherein the recognizing is performed by recognizing whether the objects pointed out by the pointer on the screen can be executed.

19. The control method of a motion based pointing apparatus providing haptic feedback according to claim 15, wherein the outputting haptic operation is performed by colliding the vibrating body of the linear vibrator or generating vibration in one way direction or two ways.

20. The control method of a motion based pointing apparatus providing haptic feedback according to claim 15, wherein the outputting haptic operation is performed by generating collision or vibration in at least one of up, down, left, right, front, and rear directions using the vibrating body of the linear vibrator.
